(19) United States
(12) Patent Application Publication
(10) Pub. No.: US 2026/0227182 A1
(43) Pub. Date: Aug. 6, 2026

(54) SCAN SYSTEM, METHOD, AND PROGRAM

(71) Applicant: FUJIFILM Corporation, Tokyo (JP)

(72) Inventors: Shinichi FUJIMOTO, Saitama-shi (JP); Koichi TANAKA, Saitama-shi (JP); Kazuki ISHIDA, Saitama-shi (JP); Toshiki KOBAYASHI, Saitama-shi (JP)

(73) Assignee: FUJIFILM Corporation, Tokyo (JP)

(21) Appl. No.: 19/630,598

(22) Filed: Mar. 27, 2026

Related U.S. Application Data
(63) Continuation of application No. PCT/JP2024/032181, filed on Sep. 9, 2024.

(30) Foreign Application Priority Data
Sep. 28, 2023 (JP) 2023-168635

(51) Int. Cl. G01B 11/25; G01C 11/02

(52) U.S. Cl. CPC G01B 11/2513; G01B 11/2509; G01B 11/2518; G01B 11/2545; G01C 11/025

(57) ABSTRACT

Provided are a scan system, a method, and a program for detecting at least one of a transmittance or a transmitted color of a region of an object of which at least a part is transparent. The scan system includes an illumination device (20) that irradiates an object (50) with illumination light, a first imaging apparatus (10) that images the object (50) illuminated by the illumination device (20), and a processor. The processor is configured to acquire a plurality of first captured images of which imaging directions with respect to the object are different (50) from the first imaging apparatus (10), and detect at least one of the transmittance or the transmitted color of the region of the object (50) through which the illumination light is transmitted, based on the plurality of first captured images.

### CROSS-REFERENCE TO RELATED APPLICATIONS

The present application is a Continuation of PCT International Application No. PCT/JP2024/032181 filed on Sep. 9, 2024 claiming priority under 35 U.S.C § 119(a) to Japanese Patent Application No. 2023-168635 filed on Sep. 28, 2023. Each of the above applications is hereby expressly incorporated by reference, in its entirety, into the present application.

### BACKGROUND OF THE INVENTION

### 1. Field of the Invention

The present invention relates to a scan system, a method, and a program, and particularly relates to a technique for scanning an object of which at least a part is transparent.

### 2. Description of the Related Art

In the related art, a method of measuring a height (height profile) of a substantially transparent object having a refractive index, such as a pellicle and a coating, has been proposed (JP2008-506957A).

The method described in JP2008-506957A is based on a high-speed moire interferometry method, acquires an image of an object corresponding to an intensity pattern projected onto a pellicle, and measures a height of the object from a reference plane using a phase of an intensity pattern associated with the object, a refractive index of the object, and a reference phase of an intensity pattern corresponding to the reference plane, using the acquired image.

JP2018-146363A describes a three-dimensional position measurement system including a plurality of imaging units that image an object from different directions, and a processing unit that acquires images captured by the plurality of imaging units and measures a three-dimensional position of a measurement target point by processing the images.

The three-dimensional position measurement system described in JP2018-146363A measures the three-dimensional position of the measurement target point, which is a vertex of the ice adhered to the surface of the object, in particular, in a case where the ice is adhered to the surface of the object.

### SUMMARY OF THE INVENTION

One embodiment according to the disclosed technology provides a scan system, a method, and a program for detecting at least one of a transmittance or a transmitted color of a region of an object of which at least a part is transparent.

The present invention according to a first aspect is a scan system comprising: an illumination device that irradiates an object with illumination light; a first imaging apparatus that images the object illuminated by the illumination device; and a processor, in which the processor is configured to: acquire, from the first imaging apparatus, a plurality of first captured images of which imaging directions with respect to the object are different; and detect at least one of a transmittance or a transmitted color of a region of the object through which the illumination light is transmitted, based on the plurality of first captured images.

In a scan system according to a second aspect of the present invention, according to the first aspect, it is preferable that the processor is configured to extract the region of the object through which the illumination light is transmitted, based on change information of the illumination light that has reached a screen on a side opposite to the illumination device with the object interposed between the illumination device and the screen.

In a scan system according to a third aspect of the present invention, according to the second aspect, the processor is configured to detect at least one of the transmittance or the transmitted color, based on image information of the region of the object through which the illumination light is transmitted in the first captured image and image information of a region of the screen on which the illumination light is directly incident without passing through the object.

In a scan system according to a fourth aspect of the present invention, according to any one of the first aspect to the third aspect, it is preferable that the illumination device includes a projection device that projects a projection pattern, and the processor is configured to extract a region of the object through which the projection pattern is transmitted, based on change information of the projection pattern that has reached a screen on a side opposite to the projection device with the object interposed between the projection device and the screen.

In a scan system according to a fifth aspect of the present invention, according to any one of the first aspect to the fourth aspect, it is preferable that the processor is configured to generate a 3D model of the object by a visual hull intersection method, based on a silhouette of the object included in the plurality of first captured images of which the imaging directions are different.

In a scan system according to a sixth aspect of the present invention, according to any one of the first aspect to the fifth aspect, it is preferable that the processor is configured to generate the 3D model of the object by photogrammetry, based on the plurality of first captured images of which the imaging directions are different.

In a scan system according to a seventh aspect of the present invention, according to the fifth aspect or the sixth aspect, it is preferable that a texture generated by using the plurality of first captured images is mapped to a surface of the 3D model.

In a scan system according to an eighth aspect of the present invention, according to the fifth aspect or the sixth aspect, it is preferable that a texture corresponding to at least one of the transmittance or the transmitted color is mapped to a surface of the 3D model in the region of the object through which the illumination light is transmitted, or at least one of the transmittance or the transmitted color is added as accessory information of the 3D model.

In a scan system according to a ninth aspect of the present invention, according to any one of the first aspect to the eighth aspect, it is preferable that the illumination device includes a projection device that projects a projection pattern, and the processor is configured to extract a region of the object through which the projection pattern is transmitted, based on the projection pattern that is included in the first captured image captured by the first imaging apparatus and that has reached a screen on a side opposite to the projection device with the object interposed between the projection device and the screen, or extract the region of the object through which the projection pattern is transmitted, based on the projection pattern on the screen and the projection pattern on the object.

In a scan system according to a tenth aspect of the present invention, according to any one of the first aspect to the ninth aspect, it is preferable that the scan system includes a second imaging apparatus that images a screen from the same side as the object with respect to the screen on a side opposite to the illumination device with the object interposed between the illumination device and the screen; or a third imaging apparatus that images the screen from a side opposite to the object with the screen interposed between the third imaging apparatus and the object, in which the processor is configured to detect at least one of the transmittance or the transmitted color of the region of the object through which the illumination light that has reached the screen is transmitted, based on a captured image obtained by the second imaging apparatus or the third imaging apparatus.

In a scan system according to an eleventh aspect of the present invention, according to any one of the first aspect to the tenth aspect, it is preferable that the illumination device includes a projection device that projects a projection pattern, and the processor is configured to: acquire, as a reference projection pattern, the projection pattern that has reached a screen on a side opposite to the projection device with the object interposed between the projection device and the screen and that is projected onto the screen in a case where the object is not present; and extract a region of the object through which the projection pattern is transmitted, based on at least one of the first captured image or the projection pattern that has reached the screen and the reference projection pattern.

In a scan system according to a twelfth aspect of the present invention, according to any one of the first aspect to the eleventh aspect, it is preferable that the scan system includes a rotary table on which the object is placed, in which the plurality of first captured images are images captured by the first imaging apparatus at respective different rotation positions of the rotary table.

In a scan system according to a thirteenth aspect of the present invention, according to the twelfth aspect, it is preferable that a surface of the rotary table functions as a part of a screen on a side opposite to the illumination device with the object interposed between the illumination device and the screen.

In a scan system according to a fourteenth aspect of the present invention, according to the twelfth aspect or the thirteenth aspect, it is preferable that a pattern usable for photogrammetry based on the plurality of first captured images of which the imaging directions are different is provided on the surface of the rotary table.

The present invention according to a fifteenth aspect is a scan method in a scan system including an illumination device that irradiates an object with illumination light, a first imaging apparatus that images the object illuminated by the illumination device, and a processor, the scan method comprising: a step of acquiring, via the processor, from the first imaging apparatus, a plurality of first captured images of which imaging directions with respect to the object are different; and a step of detecting, via the processor, at least one of a transmittance or a transmitted color of a region of the object through which the illumination light is transmitted, based on the plurality of first captured images.

In a scan method according to a sixteenth aspect of the present invention, according to the fifteenth aspect, it is preferable that the scan method includes a step of generating, via the processor, a 3D model of the object by a visual hull intersection method, based on a silhouette of the object included in the plurality of first captured images of which the imaging directions are different.

In a scan method according to a seventeenth aspect of the present invention, according to the fifteenth aspect or the sixteenth aspect, it is preferable that the scan method includes a step of generating, via the processor, the 3D model of the object by photogrammetry, based on the plurality of first captured images of which the imaging directions are different.

The present invention according to an eighteenth aspect is a scan program comprising: causing a computer to execute: a function of causing a first imaging apparatus to image an object irradiated with illumination light from an illumination device and capture a plurality of first captured images of which imaging directions with respect to the object are different; a function of acquiring the plurality of first captured images captured by the first imaging apparatus; and a function of detecting at least one of a transmittance or a transmitted color of a region of the object through which the illumination light is transmitted, based on the plurality of first captured images.

In a scan program according to a nineteenth aspect of the present invention, according to the eighteenth aspect, it is preferable that the scan program includes at least one of a function of generating a 3D model of the object by a visual hull intersection method based on a silhouette of the object included in the plurality of first captured images of which the imaging directions are different, or a function of generating the 3D model of the object by photogrammetry based on the plurality of first captured images of which the imaging directions are different.

### BRIEF DESCRIPTION OF THE DRAWINGS

FIG. 1 is a main part external view showing a first embodiment of a scan system according to the present invention.

FIG. 2 is a view showing an example of a first captured image in which an object and the like are imaged by an imaging apparatus shown in FIG. 1.

FIG. 3 is a perspective view of a rotary table shown in FIG. 1.

FIG. 4 is a block diagram showing an embodiment of a hardware configuration of an information processing apparatus constituting the scan system according to the present invention.

FIG. 5 is a flowchart showing an embodiment of a scan method according to the present invention.

FIG. 6 is a main part external view showing a second embodiment of the scan system according to the present invention.

FIG. 7 is a view showing another example of the first captured image captured by the first imaging apparatus.

### DESCRIPTION OF THE PREFERRED EMBODIMENTS

Hereinafter, preferred embodiments of a scan system, a method, and a program according to the present invention will be described with reference to the accompanying drawings.

### Outline of Present Invention

In a case where the object is not transparent, a three-dimensional (3D) model of the object by 3D scanning of the object can be well modeled by photogrammetry using a plurality of captured images of which imaging directions with respect to the object are different.

On the other hand, in a case where the object is a transparent substance or a translucent substance, the 3D model cannot be correctly generated in many cases, and there is a problem that the transparent region cannot be detected even in object detection on a 2D captured image.

Therefore, the object to be scanned is irradiated (preferably, a projection pattern is projected) with illumination light, the screen is placed in the background, the object is imaged together with the screen, a region (transparent region) of the object through which the illumination light is transmitted is extracted based on the captured image, and at least one of a transmittance or a transmitted color of the transparent region is detected. In the present example, the transparent region includes a translucent region.

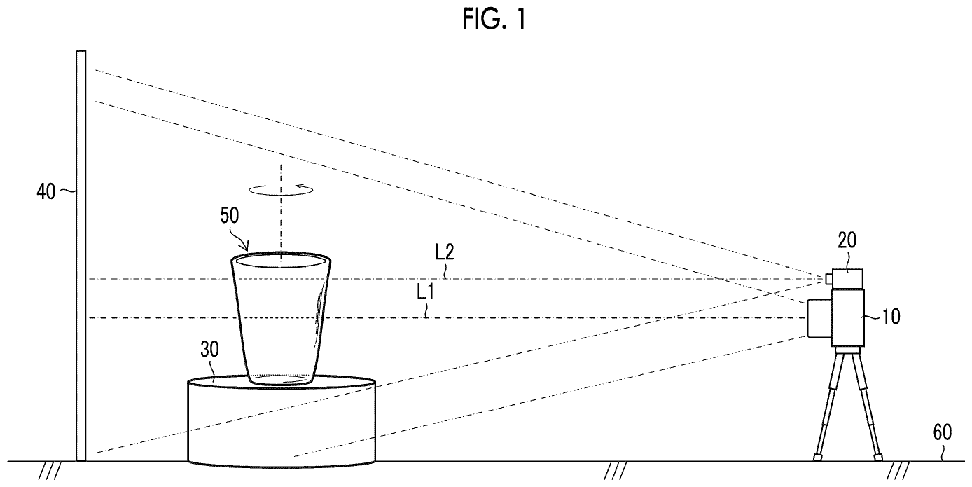

FIG. 1 is a main part external view showing a first embodiment of a scan system according to the present invention.

The scan system shown in FIG. 1 is configured of a first imaging apparatus 10, an illumination device 20, a rotary table 30, and a screen 40.

An object 50 is placed on the rotary table 30. The object 50 of the present example is a transparent cup. The screen 40 is installed on a side opposite to the illumination device 20 with the object 50 on the rotary table 30 interposed therebetween.

In FIG. 1, the first imaging apparatus 10 is fixed to a tripod installed on a floor surface 60, and the illumination device 20 can be fixed to, for example, a hot shoe of the first imaging apparatus 10. The illumination device 20 is not limited to the one fixed to the first imaging apparatus 10.

In addition, in FIG. 1, L1 indicates an optical axis of the first imaging apparatus 10, and L2 indicates an optical axis of the illumination device 20. The optical axis L1 and the optical axis L2 shown in FIG. 1 are parallel to each other in an up-down direction in FIG. 1, but may be parallel to each other in a left-right direction or in up-down-left-right directions, and the directions of the optical axes L1 and L2 may be different.

The first imaging apparatus 10 can use a general-purpose imaging apparatus, but may comprise a 3D model imaging mode for performing scanning imaging or the like according to the present invention.

The illumination device 20 irradiates the object 50 with illumination light, but a shadow (silhouette) of the object 50 is formed on the screen 40 by the illumination light.

Since the first imaging apparatus 10 and the illumination device 20 have a parallax, in a case where the object 50 is opaque, the first imaging apparatus 10 can image a shadow of the object 50 on the screen 40 (shadow of a part of the object 50). In addition, in a case where a part or all of the object 50 is transparent, the first imaging apparatus 10 can acquire (image) change information of the illumination light that has transmitted through the object 50 and has reached the screen 40. Details of the change information of the illumination light will be described below.

In addition, the rotary table 30 and the screen 40 are provided on the floor surface 60 as in the tripod. The screen 40 is not limited to a projection-only screen, and a wall, a partition, a table, or the like having a uniform density may be used.

The rotary table 30 rotates at a constant rotation speed together with the object 50, and the first imaging apparatus 10 performs imaging a plurality of times during at least one rotation of the object 50. As a result, the first imaging apparatus 10 images the object 50 at respective different rotation positions of the rotary table 30, and as a result, acquires a plurality of captured images (first captured images) in which imaging directions with respect to the object 50 are different.

In addition, it is preferable that the height and/or the tilt angle of the first imaging apparatus 10 are changed each time the rotary table 30 rotates once, and the object is imaged at various heights and angles.

In addition, it is preferable that the first imaging apparatus 10 reduces a stop (increases a stop value (F number)), uses a wide-angle lens as an imaging lens, and focuses on the entire object 50 and the screen 40 (so that the object 50 and the screen 40 are within a depth of field). This is because the contour of the shadow on the screen 40 can be clearly imaged. Therefore, it is preferable that the screen 40 is provided immediately after the object 50.

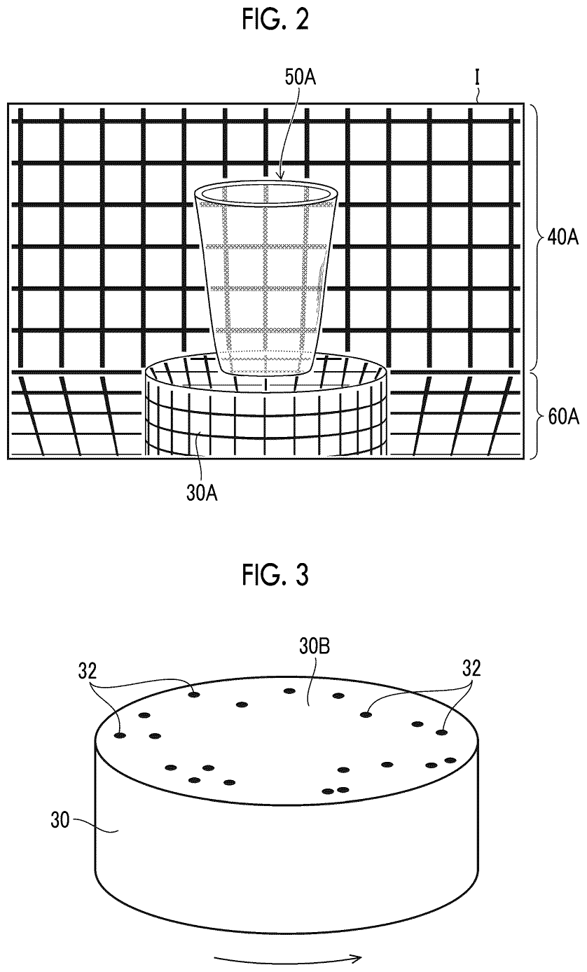

FIG. 2 is a diagram showing an example of a first captured image in which the object and the like are imaged by the imaging apparatus shown in FIG. 1.

The illumination device 20 shown in FIG. 1 includes a projection device that projects a projection pattern. The illumination device 20 can irradiate (project) the illumination light or project the projection pattern (for example, lattice-shaped pattern light) instead of the illumination light.

A first captured image I shown in FIG. 2 is a captured image by the first imaging apparatus 10 in a case where the lattice-shaped pattern light is projected from the illumination device 20. The lattice-shaped pattern shown in the first captured image I shown in FIG. 2 is an image showing the lattice-shaped pattern light projected from the illumination device 20, and is represented by a black line for convenience.

In FIG. 2, the first captured image I includes a region 30A corresponding to the rotary table 30, a region 40A corresponding to the screen 40, a region 50A corresponding to the object 50, and a region 60A corresponding to the floor surface 60.

Since the object 50 of the present example is a transparent cup, the pattern light that has transmitted through the object 50 reaches the screen 40, and the first imaging apparatus 10 images reflected light of the pattern light that has reached the screen 40 and the pattern light reflected in a region other than the region corresponding to the object 50 (for example, the pattern light reflected in a region of the screen 40 on which the pattern light is directly incident without passing through the object 50). It goes without saying that the lattice-shaped pattern light is not the only thing imaged.

The pattern light that has transmitted through the object 50 and has reached the screen 40 is attenuated according to the transmittance of the object 50, and in a case where the object 50 has a transmitted color, the color corresponding to the transmitted color is changed. In addition, the pattern light that has reached the screen 40 is reflected by the screen 40 and is transmitted through the object 50 again to be imaged by the first imaging apparatus 10.

The pattern light that has transmitted through the object 50 and has reached the screen 40, is reflected by the screen 40, and is transmitted through the object 50 again is attenuated according to the transmittance of the object 50 and is colored according to the transmitted color in a case where the object 50 has a transmitted color, as compared with the pattern light reflected by the screen 40 directly.

In addition, in a case where the object 50 is a transparent cup as in the present example, the transmittance of the pattern light is low in a region of an end or an edge of the cup, and the pattern light is diffused due to a lens effect caused by a change in thickness.

Furthermore, in a case where information (shape, color, and the like) of the projected pattern light is known, change information (deviation or deformation of the pattern light) between the pattern light directly projected onto the screen 40 and the pattern light transmitted through the object 50 and projected onto the screen 40 can be used for extracting the transparent region of the object 50, and the nature of the transparent region including the information on the refractive index may be known.

Therefore, a region (transparent region) of the object 50 through which the pattern light is transmitted can be separated and extracted from the background based on an image showing the pattern light shown in the first captured image I.

In addition, the transmittance of the transparent region of the object 50 can be detected based on a ratio of brightness values of an image showing the pattern light that has transmitted through the object 50 and an image showing the pattern light that is directly incident on the screen 40 without transmitting through the object 50. Furthermore, the transmitted color of the transparent region of the object 50 can be detected based on a difference in color information between an image showing the pattern light that has transmitted through the object 50 and an image showing the pattern light directly projected onto the screen 40.

Furthermore, a projection pattern by the pattern light projected onto the screen 40 in a case where the object 50 is not present may be acquired as a reference projection pattern without placing the object 50 on the rotary table 30. In this case, the object 50 is placed on the rotary table 30, a plurality of first captured images of which imaging directions with respect to the object 50 are different are captured, a transparent region of the object 50 through which the projection pattern is transmitted is extracted based on at least one of the plurality of first captured images or the projection pattern that has reached the screen 40 and a reference projection pattern separately captured, and at least one of the transmittance or the transmitted color of the transparent region can be detected.

FIG. 3 is a perspective view of the rotary table shown in FIG. 1.

A pattern that can be used for photogrammetry based on the plurality of first captured images of which the imaging directions are different is provided on a surface 30B of the rotary table 30 shown in FIG. 3, and in the present example, a random point group pattern 32 having a known positional relationship is provided.

The rotation angle of the rotary table 30 can be detected by matching the point group pattern 32 shown in the plurality of first captured images of which the imaging directions are different, and the actual size of the object 50 can be obtained from an interval between the points of the point group pattern 32 shown in the first captured image. The surface 30B of the rotary table 30 on which the object 50 is placed can be used as a part of the screen (see FIG. 2).

### Information Processing Apparatus

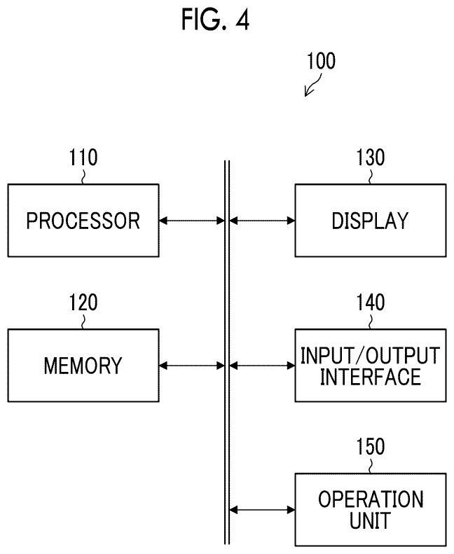

FIG. 4 is a block diagram showing an embodiment of a hardware configuration of an information processing apparatus constituting the scan system according to the present invention.

For example, an information processing apparatus 100 shown in FIG. 4 may be built in the first imaging apparatus 10, or may be configured by a personal computer, a workstation, or the like that is separate from the first imaging apparatus 10.

The information processing apparatus 100 comprises a processor 110, a memory 120, a display 130, an input/output interface 140, and an operation unit 150.

The processor 110 is configured of a central processing unit (CPU) or the like, and integrally controls each unit of the information processing apparatus 100, executes the scan program to execute scanning imaging by the first imaging apparatus 10, and acquires a plurality of first captured images of which imaging directions with respect to the object 50 are different, which are captured by the first imaging apparatus 10 by the scanning imaging. The processor 110 generates a 3D model of the object 50 based on the acquired plurality of first captured images, and executes information processing such as detecting at least one of the transmittance or the transmitted color of the transparent region of the object 50 through which the illumination light (or the projection pattern such as the lattice-shaped pattern light) irradiated from the illumination device 20 is transmitted. Details of the information processing by the processor 110 will be described below.

The memory 120 includes a flash memory, a read-only memory (ROM), a random-access memory (RAM), a hard-disk drive, and the like. The flash memory, the ROM, or the hard disk device is a non-volatile memory that stores an operating system, various programs including the scan program according to the embodiment of the present invention, and the like. The scan program may include a program that generates a 3D model of the object based on the plurality of first captured images of which imaging directions with respect to the object are different.

In addition, the non-volatile memory such as the flash memory and the hard disk device can store the plurality of first captured images of which the imaging directions with respect to the object are different captured by the first imaging apparatus 10, the 3D model of the object generated from the plurality of first captured images, and information on the projection pattern (information on a shape of the pattern light in a case where the lattice-shaped pattern light is projected from the illumination device 20).

The RAM functions as a work area of processing by the processor 110. In addition, various programs stored in the flash memory or the like and the first captured image or the like are temporarily stored. Meanwhile, a part (RAM) of the memory 120 may be built in the processor 110.

The display 130 displays a screen for operating the information processing apparatus 100, and can display the first captured image read from the memory 120 and the 3D model.

The input/output interface 140 includes a connection unit that can be connected to an external device, a communication unit that can be connected to a network, and the like. As the connection unit that is connectable to the external device, a universal serial bus (USB), a high-definition multimedia interface (HDMI) (HDMI is a registered trademark), and the like can be applied.

The information processing apparatus 100 can be configured as an apparatus independent of the first imaging apparatus 10, and in this case, the processor 110 can acquire the plurality of first captured images of which the imaging directions with respect to the object are different from the first imaging apparatus 10 via the input/output interface 140, or can acquire the plurality of first captured images from the cloud via the input/output interface 140 in a case where the plurality of first captured images are stored in the cloud. In addition, the processor 110 can store the plurality of first captured images acquired in this way in the memory 120.

The operation unit 150 includes a pointing device such as a mouse, a keyboard, and the like, and functions as a part of a graphical user interface (GUI) that receives an instruction input by a user operation using a display screen of the display 130.

In a case where the information processing apparatus 100 is included in the first imaging apparatus 10, the display 130 and the operation unit 150 correspond to a monitor, an operation button, and the like on a rear surface of the first imaging apparatus 10.

In a case of generating the 3D model of the object 50, the processor 110 of the information processing apparatus 100 irradiates the object 50 with the lattice-shaped pattern light from the illumination device 20, and rotates the rotary table 30 at a constant speed to rotate the object 50 on the rotary table 30.

In addition, the processor 110 causes the first imaging apparatus 10 to image the object 50 a plurality of times during a period in which the rotary table 30 rotates once. Since the object 50 is rotating, the first imaging apparatus 10 can capture the plurality of first captured images of which the imaging directions with respect to the object 50 are different.

The driving of the rotary table 30 and the irradiation with the pattern light from the illumination device 20 are not limited to being performed in response to an instruction from the processor 110, and may be performed in response to an instruction from the user.

In addition, the scanning imaging of the object 50 by the first imaging apparatus 10 is not limited to being performed in response to an instruction from the processor 110, and may be performed in response to an instruction from the user. For example, the first imaging apparatus 10 is set to continuous imaging (continuous shooting), and the user need only press a shutter button during the period in which the rotary table 30 rotates once.

In a case where the scanning imaging of the object 50 is performed by the first imaging apparatus 10 and the plurality of first captured images of which the imaging directions with respect to the object 50 are different are captured, the processor 110 acquires the plurality of first captured images of which the imaging directions with respect to the object 50 are different from the first imaging apparatus 10 via the input/output interface 140. In a case where the plurality of first captured images are stored in the cloud, the plurality of first captured images can be acquired from the cloud via the input/output interface 140, or the plurality of first captured images can be acquired via a recording medium of the first imaging apparatus 10.

### Scan Method

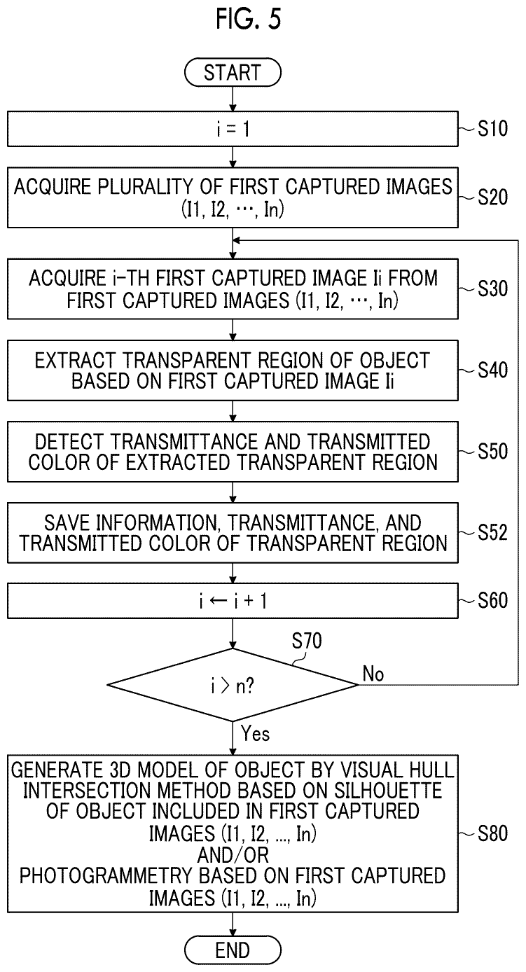

FIG. 5 is a flowchart showing an embodiment of the scan method according to the present invention, and is particularly a flowchart showing a flow from the acquisition of the plurality of first captured images by the processor 110 to the generation of the 3D model of the object 50.

In FIG. 5, the processor 110 sets a parameter i indicating a specific first captured image among the plurality of first captured images to 1 (step S10).

Subsequently, the processor 110 acquires the plurality of first captured images I in which the imaging directions with respect to the object 50 are different from the first imaging apparatus 10, and stores the acquired plurality of first captured images I in the memory 120 (step S20). In this case, the processor 110 assigns numbers 1 to n corresponding to the imaging order to the plurality of first captured images I, and generates first captured images (I1, I2, . . . , In). n is a value corresponding to the number of the plurality of first captured images I.

The processor 110 acquires the i-th first captured image Ii captured in the order indicated by the parameter i from the first captured images (I1, I2, . . . , In) (step S30). In a case of acquiring the first captured image Ii first, since i=1 is set (see step S10), the first captured image I1 is acquired.

Next, the processor 110 extracts the transparent region of the object 50 based on the first captured image Ii acquired in step S20 (step S40). The transparent region is extracted by extracting the transparent region of the object through which the pattern light is transmitted based on the change information of the illumination light (in the present example, the lattice-shaped pattern light) that has reached the screen 40. The pattern light does not transmit through the object in a case where the object is opaque or in a case where the object includes an opaque region (opaque region). On the other hand, the pattern light transmits through the transparent region of the object 50 and reaches the screen 40, but the deviation or deformation, the brightness, the color, and the like of the pattern light change between the pattern light directly projected onto the screen 40 and the pattern light transmitted through the object 50 and projected onto the screen 40. The change information of the pattern light can be used for extracting the transparent region of the object 50, and it is possible to detect the nature of the transparent region including the information on the refractive index.

Therefore, the processor 110 can separate and extract the transparent region of the object 50 through which the pattern light is transmitted from the background based on an image showing the pattern light shown in the first captured image Ii. In a case of the lattice-shaped pattern light of the present example, the change in the lattice due to the refraction or the like of the pattern light at the boundary portion between the pattern light that has transmitted through the transparent region of the object 50 and has reached the screen 40 and the pattern light directly projected onto the screen 40 is clear, and the transparent region including the contour of the transparent region of the object 50 can be more accurately extracted.

Subsequently, the processor 110 detects at least one of the transmittance or the transmitted color of the transparent region of the object 50 extracted in step S40. In the present example, the transmittance and the transmitted color of the transparent region are detected. That is, the processor 110 detects the transmittance and the transmitted color of the object 50 based on image information of the transparent region of the object 50 through which the pattern light is transmitted, which is included in the first captured image Ii, and image information of a region of the screen 40 on which the pattern light is directly incident without passing through (transmitting through) the object 50. For example, the transmittance of the transparent region of the object 50 can be detected based on a ratio of a brightness value of an image showing the pattern light that has reached the screen 40 without transmitting through the object 50 to a brightness value of an image showing the pattern light that has transmitted through the object 50 and has reached the screen 40, and the transmitted color of the transparent region of the object 50 can be detected based on a difference in color information between an image showing the pattern light that has transmitted through the object 50 and an image showing the pattern light directly projected onto the screen 40.

The transmittance and the color information of the transparent region of the object 50 may be obtained for each local region of the transparent region, or may be obtained as an average value of the entire transparent region. In addition, in a case of detecting the transmittance and the transmitted color of the transparent region of the object 50 based on the first captured image Ii, the detection is performed in consideration of the fact that the image of the pattern light that has transmitted through (twice) the transparent region of the object 50 is imaged in the first captured image.

The processor 110 stores the information, the transmittance, and the transmitted color of the transparent region of the object 50 detected based on the first captured image Ii in the memory 120 in association with the first captured image Ii (step S52).

Next, the parameter i is incremented by 1 (step S60), and it is determined whether or not the parameter i exceeds n (i>n) (step S70). In a case where the parameter i does not exceed n (in a case of i≤n), the processing transitions to step S30, and the processing from step S30 to step S70 is repeatedly executed, and in a case where the parameter i exceeds n (in a case of i>n), the processing transitions to step S80.

In step S80, the processor 110 generates a 3D model of the transparent region of the object 50 by a visual hull intersection method based on the silhouette of the transparent region of the object 50 using the information (silhouette) of the transparent region included in the plurality of first captured images (I1, I2, . . . , In) stored in the memory 120. In addition, the 3D model of the transparent region of the object 50 is generated by photogrammetry based on the information (image extracted corresponding to the transparent region) of the transparent region included in the plurality of first captured images (I1, I2, . . . , In) in addition to the generation of the 3D model by the visual hull intersection method, or instead of the generation of the 3D model by the visual hull intersection method.

It is preferable that a texture corresponding to at least one of the transmittance or the transmitted color of the transparent region is mapped to a surface of the 3D model of the transparent region of the object 50 generated by the visual hull intersection method, and/or at least one of the transmittance or the transmitted color of the transparent region is added as accessory information of the 3D model of the transparent region.

In a case of generating the 3D model of the transparent region of the object 50 by the photogrammetry, it is preferable to erase the projection pattern corresponding to the pattern light from the image of the extracted transparent region by image processing, or to use the image of the transparent region extracted from the captured image in a case where the uniform illumination light is irradiated to the object 50 from the illumination device 20 instead of the pattern light.

The processor 110 stores the 3D model of the transparent region of the object 50 generated in this way in the memory 120.

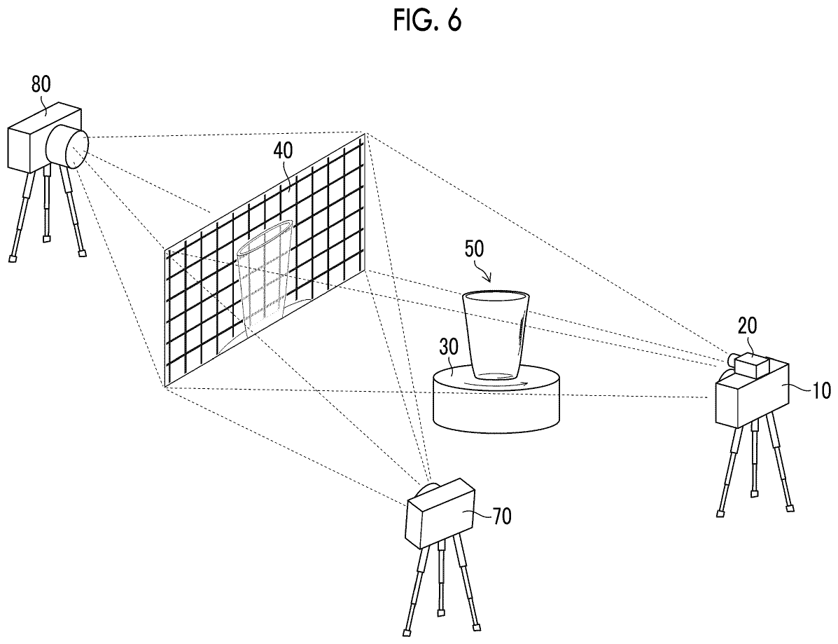

FIG. 6 is a main part external view showing a second embodiment of the scan system according to the present invention.

Components shown in FIG. 6 common to the first embodiment shown in FIG. 1 will be denoted by the same reference numerals as those shown in FIG. 1, and the detailed description thereof will be omitted.

The second embodiment shown in FIG. 6 is different from the first embodiment shown in FIG. 1 in that a second imaging apparatus 70 and a third imaging apparatus 80 are added.

The second imaging apparatus 70 is an imaging apparatus that images the screen 40 from the same side as the object 50 with respect to the screen 40 on a side opposite to the illumination device 20 with the object 50 interposed therebetween.

The second imaging apparatus 70 can image the lattice-shaped pattern light that has transmitted through the object 50 and has reached the screen 40, the pattern light that is directly irradiated onto the screen 40 without passing through the object 50, and an image showing a shadow (silhouette) of an opaque region in a case where the object 50 has the opaque region by imaging the screen 40 from a surface side thereof.

The second imaging apparatus 70 does not directly image the object 50, but images the screen 40 on which the pattern light or the like that transmits through the object 50 rotating with the rotation of the rotary table 30 is projected, and thus images a plurality of captured images of which imaging directions with respect to the object 50 are different indirectly.

Therefore, the processor 110 can generate the 3D model of the transparent region of the object 50 based on a plurality of captured images of which the imaging directions with respect to the object 50 are different, which are captured by the second imaging apparatus 70, in the same manner as the plurality of first captured images captured by the first imaging apparatus 10, and can detect the transmittance and the transmitted color of the transparent region of the object 50. In a case of generating the 3D model of the object 50 from the plurality of captured images of the pattern light that has reached the screen 40 in a case where the irradiation direction of the pattern light with respect to the object 50 is substantially different, it is preferable to generate the 3D model of the transparent region of the object 50 by the visual hull intersection method using the information (silhouette) of the transparent region of the object 50.

The third imaging apparatus 80 is an imaging apparatus that images the screen from a side opposite to the object 50 with the screen 40 interposed therebetween. In this case, a rear projection screen that diffuses and transmits light incident on the screen 40 is used as the screen 40.

The third imaging apparatus 80 can image the lattice-shaped pattern light that has transmitted through the object 50 and has reached the screen 40, the pattern light or the like that is directly incident on the screen 40 without passing through the object 50, and an image showing light diffused and transmitted by the screen 40 by imaging the screen 40 from a back surface side thereof.

The processor 110 can generate the 3D model of the transparent region of the object 50 based on a plurality of captured images captured by the third imaging apparatus 80, in the same manner as the plurality of captured images captured by the second imaging apparatus 70, and can detect the transmittance and the transmitted color of the transparent region of the object 50.

The scan system of the second embodiment shown in FIG. 6 comprises the second imaging apparatus 70 and the third imaging apparatus 80 in addition to the first imaging apparatus 10, but the present invention is not limited thereto, and a system comprising only the second imaging apparatus 70 or only the third imaging apparatus 80 may be used.

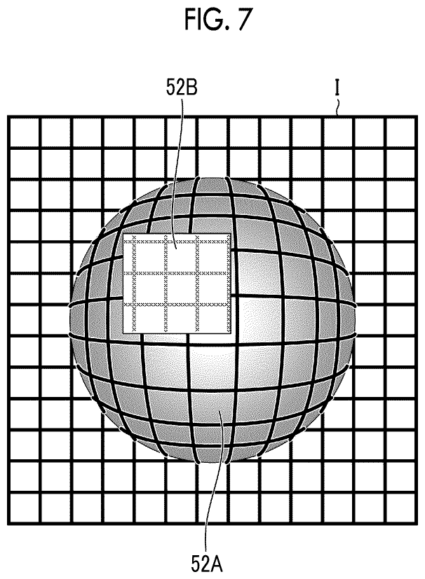

FIG. 7 is a diagram showing another example of the first captured image captured by the first imaging apparatus.

The first captured image shown in FIG. 7 is an image in which an object of a sphere having an opaque region 52A and a transparent region 52B is imaged by the first imaging apparatus 10 (see FIG. 1).

The processor 110 acquires a plurality of first captured images of which imaging directions with respect to the sphere captured by the first imaging apparatus 10 are different, and separates and extracts the opaque region 52A and the transparent region 52B of the sphere.

In addition, for the transparent region 52B of the sphere, the processor 110 detects at least one of the transmittance or the transmitted color of the transparent region 52B.

Then, the processor 110 generates the 3D model of the opaque region 52A of the sphere by photogrammetry based on a plurality of images of which the imaging directions are different and showing the opaque region 52A of the sphere. A texture corresponding to the polygon is mapped to a micro region of a surface of the opaque region 52A of the 3D model.

In addition, the processor 110 generates the 3D model of the transparent region 52B of the sphere by a visual hull intersection method based on a plurality of silhouettes in which the imaging directions are different and showing the transparent region 52B of the sphere. The processor 110 can map a texture corresponding to at least one of the transmittance or the transmitted color of the transparent region 52B to a surface of the 3D model of the transparent region 52B.

These 3D models can be synthesized. In addition, the 3D model of the opaque region 52A of the sphere may be generated, a portion of a surface of the sphere without an opaque texture may be set to be transparent, and a texture corresponding to at least one of the transmittance or the transmitted color of the transparent region 52B may be mapped.

In addition, it is preferable to erase the projection pattern corresponding to the lattice-shaped pattern light included in the texture of the 3D model by image processing, or to use the image extracted from the first captured image in a case where the uniform illumination light is irradiated to the object 50 from the illumination device 20 instead of the pattern light.

### Other

In the present embodiment, the object 50 is placed on the rotary table 30, the rotary table 30 is rotated, and the object 50 is imaged by the first imaging apparatus 10 to acquire the plurality of first captured images of which the imaging directions with respect to the object 50 are different, but the present invention is not limited thereto. The plurality of first captured images of which the imaging directions are different may be acquired by performing imaging while rotating the first imaging apparatus 10 and the illumination device 20 with respect to the stationary object 50, and in this case, the user may hold the first imaging apparatus 10 and perform imaging while changing the imaging direction, the imaging position, and the like.

In the present embodiment, for example, a hardware structure of a processing unit that executes various types of processing, such as a central processing unit (CPU), includes various processors to be described below. The various processors include a CPU that is a general-purpose processor functioning as various processing units by executing software (programs), a programmable logic device (PLD) that is a processor of which the circuit configuration can be changed after manufacture, such as a field programmable gate array (FPGA), a dedicated electrical circuit that is a processor having a circuit configuration designed exclusively to perform specific processing, such as an application specific integrated circuit (ASIC), and the like.

One processing unit may be composed of one of the various processors or may be composed of two or more processors of the same type or different types (for example, a plurality of FPGAs or a combination of a CPU and an FPGA). A plurality of processing units may be composed of one processor. A first example of the plurality of processing units composed of one processor is, as represented by a computer such as a client and a server, one processor composed of a combination of one or more CPUs and software, in which the processor functions as the plurality of processing units. A second example is, as represented by a system on chip (SoC) and the like, use of a processor that implements functions of the whole system including the plurality of processing units in one integrated circuit (IC) chip. In this way, various processing units are configured using one or more of the various processors as the hardware structure.

Further, more specifically, the hardware structure of the various processors is an electric circuit (circuitry) obtained by combining circuit elements such as semiconductor elements.

In addition, the present invention includes a scan program causing a computer to execute the scan method according to the present invention by being installed in the computer, and a non-transitory computer-readable recording medium on which the program is recorded.

The present invention is not limited to the above embodiments and can be subjected to various modifications without departing from the spirit of the present invention.

### EXPLANATION OF REFERENCES

10: first imaging apparatus
20: illumination device
30: rotary table
32: point group pattern
40: screen
50: object
60: floor surface
60A: region
70: second imaging apparatus
80: third imaging apparatus
100: information processing apparatus
110: processor
120: memory
130: display
140: input/output interface
150: operation unit
L1, L2: optical axis
S10 to S80: step

What is claimed is:

1. A scan system comprising:
an illumination device that irradiates an object with illumination light;
a first imaging apparatus that images the object illuminated by the illumination device; and
a processor,
wherein the processor is configured to:
acquire, from the first imaging apparatus, a plurality of first captured images of which imaging directions with respect to the object are different; and
detect at least one of a transmittance or a transmitted color of a region of the object through which the illumination light is transmitted, based on the plurality of first captured images.

2. The scan system according to claim 1,
wherein the processor is configured to extract the region of the object through which the illumination light is transmitted, based on change information of the illumination light that has reached a screen on a side opposite to the illumination device with the object interposed between the illumination device and the screen.

3. The scan system according to claim 2,
wherein the processor is configured to detect at least one of the transmittance or the transmitted color, based on image information of the region of the object through which the illumination light is transmitted in the first captured image and image information of a region of the screen on which the illumination light is directly incident without passing through the object.

4. The scan system according to claim 1,
wherein the illumination device includes a projection device that projects a projection pattern, and
the processor is configured to extract a region of the object through which the projection pattern is transmitted, based on change information of the projection pattern that has reached a screen on a side opposite to the projection device with the object interposed between the projection device and the screen.

5. The scan system according to claim 1,
wherein the processor is configured to generate a 3D model of the object by a visual hull intersection method, based on a silhouette of the object included in the plurality of first captured images of which the imaging directions are different.

6. The scan system according to claim 5,
wherein the processor is configured to generate the 3D model of the object by photogrammetry, based on the plurality of first captured images of which the imaging directions are different.

7. The scan system according to claim 6,
wherein a texture generated by using the plurality of first captured images is mapped to a surface of the 3D model.

8. The scan system according to claim 5,
wherein a texture corresponding to at least one of the transmittance or the transmitted color is mapped to a surface of the 3D model in the region of the object through which the illumination light is transmitted, or at least one of the transmittance or the transmitted color is added as accessory information of the 3D model.

9. The scan system according to claim 1,
wherein the illumination device includes a projection device that projects a projection pattern, and
the processor is configured to extract a region of the object through which the projection pattern is transmitted, based on the projection pattern that is included in the first captured image captured by the first imaging apparatus and that has reached a screen on a side opposite to the projection device with the object interposed between the projection device and the screen, or extract the region of the object through which the projection pattern is transmitted, based on the projection pattern on the screen and the projection pattern on the object.

10. The scan system according to claim 1, further comprising:
a second imaging apparatus that images a screen from the same side as the object with respect to the screen on a side opposite to the illumination device with the object interposed between the illumination device and the screen; or a third imaging apparatus that images the screen from a side opposite to the object with the screen interposed between the third imaging apparatus and the object,
wherein the processor is configured to detect at least one of the transmittance or the transmitted color of the region of the object through which the illumination light that has reached the screen is transmitted, based on a captured image obtained by the second imaging apparatus or the third imaging apparatus.

11. The scan system according to claim 1,
wherein the illumination device includes a projection device that projects a projection pattern, and
the processor is configured to:
acquire, as a reference projection pattern, the projection pattern that has reached a screen on a side opposite to the projection device with the object interposed between the projection device and the screen and that is projected onto the screen in a case where the object is not present; and
extract a region of the object through which the projection pattern is transmitted, based on at least one of the first captured image or the projection pattern that has reached the screen and the reference projection pattern.

12. The scan system according to claim 1, further comprising:
a rotary table on which the object is placed,
wherein the plurality of first captured images are images captured by the first imaging apparatus at respective different rotation positions of the rotary table.

13. The scan system according to claim 12,
wherein a surface of the rotary table functions as a part of a screen on a side opposite to the illumination device with the object interposed between the illumination device and the screen.

14. The scan system according to claim 13,
wherein a pattern usable for photogrammetry based on the plurality of first captured images of which the imaging directions are different is provided on the surface of the rotary table.

15. A scan method in a scan system including an illumination device that irradiates an object with illumination light, a first imaging apparatus that images the object illuminated by the illumination device, and a processor, the scan method comprising:
a step of acquiring, via the processor, from the first imaging apparatus, a plurality of first captured images of which imaging directions with respect to the object are different; and
a step of detecting, via the processor, at least one of a transmittance or a transmitted color of a region of the object through which the illumination light is transmitted, based on the plurality of first captured images.

16. The scan method according to claim 15, further comprising:
a step of generating, via the processor, a 3D model of the object by a visual hull intersection method, based on a silhouette of the object included in the plurality of first captured images of which the imaging directions are different.

17. The scan method according to claim 15, further comprising:
a step of generating, via the processor, the 3D model of the object by photogrammetry, based on the plurality of first captured images of which the imaging directions are different.

18. A non-transitory, computer-readable tangible recording medium on which a scan program is recorded, the scan program comprising:
causing, when read by a computer, the computer to execute:
a function of causing a first imaging apparatus to image an object irradiated with illumination light from an illumination device and capture a plurality of first captured images of which imaging directions with respect to the object are different;
a function of acquiring the plurality of first captured images captured by the first imaging apparatus; and
a function of detecting at least one of a transmittance or a transmitted color of a region of the object through which the illumination light is transmitted, based on the plurality of first captured images.

19. The recording medium on which the scan program is recorded, according to claim 18, the scan program further comprising:
at least one of a function of generating a 3D model of the object by a visual hull intersection method based on a silhouette of the object included in the plurality of first captured images of which the imaging directions are different, or a function of generating the 3D model of the object by photogrammetry based on the plurality of first captured images of which the imaging directions are different.
